(19) United States
(12) Patent Application Publication
(10) Pub. No.: US 2014/0082309 A1
(43) Pub. Date: Mar. 20, 2014

(54) MEMORY CONTROL DEVICE, INFORMATION PROCESSING APPARATUS, AND MEMORY CONTROL METHOD

(71) Applicant: Fujitsu Limited, Kawasaki-shi (JP)

(72) Inventor: Soji HARA, Kawasaki (JP)

(73) Assignee: Fujitsu Limited, Kawasaki-shi (JP)

(21) Appl. No.: 14/011,814

(22) Filed: Aug. 28, 2013

(30) Foreign Application Priority Data
Sep. 20, 2012 (JP) 2012-207347

(51) Int. Cl. G06F 13/18

(52) U.S. Cl. CPC G06F 13/18
USPC 711/158

(57) ABSTRACT

Accesses to a memory divided into a plurality of units of operation are controlled. First and second units of operation from among the plurality of units of operation constitute a memory mirror. A reception circuit receives a plurality of read requests including bank identification information corresponding to both a first bank included in a first unit of operation and a second bank included in a second unit of operation, respectively. A determination circuit determines an access target of each read access so that the plurality of read accesses based on the plurality of read requests are made to the first and second units of operation alternately. The control circuit controls each read request so that each read access is made to a unit of operation determined as the access target.

### CROSS-REFERENCE TO RELATED APPLICATION

This application is based upon and claims the benefit of priority of the prior Japanese Patent Application No. 2012-207347, filed on Sep. 20, 2012, the entire contents of which are incorporated herein by reference.

### FIELD

The embodiments discussed herein are related to a memory control device, an information processing apparatus, and a memory control method.

### BACKGROUND

Today, Dual Inline Memory Modules (DIMMs) are widely used as components that constitute memories mounted in information processing apparatuses such as servers, personal computers, and the like. Accompanying increases in operation speeds, Synchronous Dynamic Random Access Memories (SDRAMs) used for recent DIMMs tend to have longer random access cycles. A random access cycle used herein refers to a time interval between an active state and the next active state in one memory bank in a memory. Herein, a memory bank may also be referred to as a bank.

As operation modes for a DIMM, the closed page mode and the open page mode are known. The closed page mode is a mode in which a bank for which an access has been terminated is precharged and the bank is kept in an idle state when there are no memory accesses. The open page mode is a mode in which a bank is not precharged even after the termination of a memory access and the bank is continuously kept in an active state as long as refreshing does not occur even when there are no accesses.

In both the closed page mode and the open page mode, memory bandwidths are sometimes narrowed noticeably when accesses to the same bank in a DIMM concentrate to cause page misses continuously. Accordingly, in an information processing apparatus that uses a DIMM, how to cover penalties related to the narrowing of memory bandwidths is a factor having decisive influence on the access performance of the memories.

Memory mirroring, which duplexes data in order to secure the reliability of the data stored in a memory, is known. As methods of realizing memory mirroring, there is a method that uses a single Memory Access Controller (MAC) and a method that uses double Memory Access Controllers.

A DIMM is divided into a plurality of physical ranks, and one or more memory banks included in each physical rank operate in accordance with the same chip select signal. Accordingly, a physical rank corresponds to one unit of operation in a DIMM.

In a memory mirroring configuration using a single MAC, one or a plurality of DIMMs each including a plurality of physical ranks are prepared and a mirror is configured by using each pair of two physical ranks included in the one or the plurality of DIMMs. One pair of two physical ranks is treated as one logical rank.

FIG. 1 illustrates an example of a memory mirroring configuration that uses a single MAC. The memory mirroring configuration illustrated in FIG. 1 includes a MAC 101 and a DIMM 102, and the DIMM 102 includes physical ranks 111-1 through 111-4. Among them, the physical ranks 111-1 and 111-2 are of one pair that constitutes the memory mirror, and the physical ranks 111-3 and 111-4 are of another pair that constitutes the memory mirror.

The physical rank 111-1 includes banks 112-1 through 112-N (N is an integer equal to or greater than 1), and each of the physical ranks 111-2 through 111-4 includes N banks similarly to physical rank 111-1.

MAC 101 receives a memory access request from a requesting source and makes an access to the DIMM 102. When the memory access request is a write request, the MAC 101 selects, in accordance with the identification information of a logical rank included in the write request, two physical ranks of a pair that corresponds to the logical rank, as the access target for the write access. The MAC 101 issues a write command to the same bank of the two physical ranks in accordance with bank identification information included in the write request and writes WRITE data to the two banks simultaneously.

In the above writing, the MAC 101 adds an Error Correcting Code (ECC) to the WRITE data and writes the data to the two banks. The added ECC is used for checking whether or not data read from the DIMM 102 is right and correcting wrong data.

When the memory access request is a read request, the MAC 101 selects, in accordance with identification information of a logical rank included in the read request, one of the two physical ranks of a pair that corresponds to the logical rank, as the access target for the read access. In accordance with the bank identification information included in the read request, the MAC 101 issues a read command to a bank of the selected physical rank and reads data from the bank so as to transfer the read data to the requesting source.

A data bus provided between the MAC 101 and the DIMM 102 is shared by all ranks, and accordingly, unlike the cases of write requests, data can be read only from one physical rank in cases of read requests. Accordingly, the access target for a read access is always one of two physical ranks.

Also, when an uncorrectable error has occurred in read data, the MAC 101 issues a read command to the other physical rank so as to read data from the same bank in that physical rank. This increases the reliability of data stored in the DIMM 102.

In a memory mirroring configuration that uses two MACs, one or more DIMMs are connected to each MAC. Further, a mirror is configured by using each pair of physical ranks included in the DIMMs connected to one MAC and the other MAC, respectively. A pair of two physical ranks is treated as one logical rank.

FIG. 2 illustrates an example of a memory mirroring configuration that uses two MACs. The memory mirroring configuration illustrated in FIG. 2 includes an interconnection unit 201, MACs 202-1 and 202-2, and DIMMs 203-1 and 203-2. The DIMM 203-1 includes physical ranks 211-1 through 211-4, and the DIMM 203-2 includes physical ranks 221-1 through 221-4.

Among them, the physical rank 211-i (i=1 through 4) and the physical rank 221-i are of one pair that constitutes the memory mirror. In this case, the MACs 202-1 and 202-2 also operate as a pair that constitutes the memory mirror.

The physical rank 211-1 includes banks 212-1 through 212-N (N is an integer equal to or greater than 1), and each of the physical ranks 211-2 through 211-4 includes N banks similarly to the physical rank 211-1. The physical rank 221-1 includes banks 222-1 through 222-N, and each of the physical ranks 221-2 through 221-4 includes N banks similarly to the physical rank 221-1.

When the interconnection unit 201 receives a write request from a requesting source, the interconnection unit 201 transmits that write request to both of the MACs 202-1 and 202-2.

The MAC 202-1 issues a write command to a corresponding bank of a corresponding physical rank in the DIMM 203-1 in accordance with the identification information of a physical rank and the bank identification information included in the write request, and writes WRITE data. Similarly to the MAC 202-1, the MAC 202-2 issues a write command to a corresponding bank of a corresponding physical rank in the DIMM 203-2, and writes WRITE data.

Thereby, WRITE data is written to two pairs of physical ranks in the DIMMs 203-1 and 203-2. Similarly to the memory mirroring configuration illustrated in FIG. 1, an ECC is added to WRITE data.

When the interconnection unit 201 has received a read request from a requesting source, the interconnection unit 201 transmits the read request to both the MACs 202-1 and 202-2, similarly to cases of write requests.

The MAC 202-1 issues a read command to a corresponding bank of a corresponding physical rank in the DIMM 203-1 in accordance with the identification information of a physical rank and the bank identification information included in the read request. Further, the MAC 202-1 reads data from that bank and transfers the READ data to the interconnection unit 201. Similarly to the MAC 202-1, the MAC 202-2 issues a read command to a corresponding bank of a corresponding physical rank in the DIMM 203-2 and reads data from that bank so as to transfer the READ data to the interconnection unit 201.

The interconnection unit 201 compares the READ data received from the MAC 202-1 and the READ data received from the MAC 202-2 and transfers that READ data to the requesting source when they are identical to each other. When they are not identical, the interconnection unit 201 determines that a hardware failure has occurred and halts the operation. When one of the pieces of the READ data has an uncorrectable error, the interconnection unit 201 transfers the other piece of the READ data to the requesting source. This increases the reliability of data stored in the DIMMs 203-1 and 203-2.

Memory mirroring in which a plurality of ranks are controlled as regular ranks and supplementary ranks, the same data is written to each of them, and the supplementary ranks are selected when an error is detected from data read from the regular ranks is also known (see Patent Document 1 for example)
Patent Document 1: Japanese Laid-open Patent Publication No. 2010-102640

### SUMMARY

According to an aspect of the embodiments, a memory control device includes a reception circuit, a determination circuit, and a control circuit, and controls an access to a memory divided into a plurality of units of operation. First and second units of operation from among the above plurality of units of operation constitute a memory mirror.

The reception circuit is configured to receive a plurality of read requests including bank identification information that corresponds to both a first bank included in a first unit of operation and a second bank included in a second unit of operation.

The determination circuit is configured to determine an access target of each read access so that a plurality of read accesses based on the above plurality of read requests are made to the first unit of operation and the second unit of operation alternately.

The control circuit is configured to control each read request so that each read access is made to a unit of operation determined as the access target.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a conventional memory mirroring configuration that uses a single MAC;

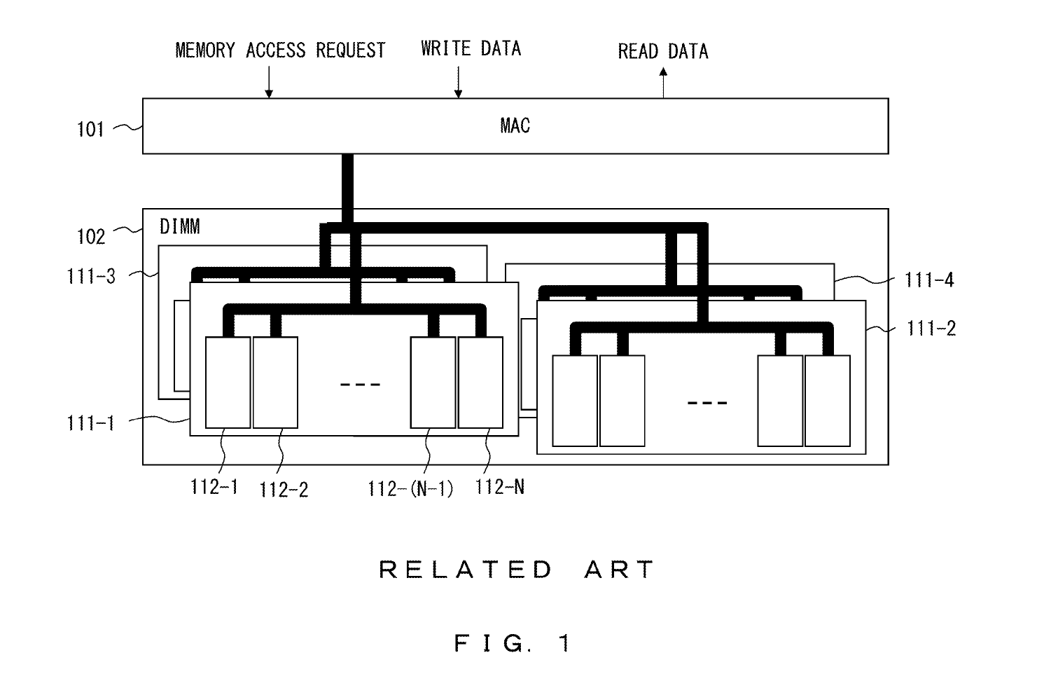

FIG. 2 illustrates a conventional memory mirroring configuration that uses two MACS;

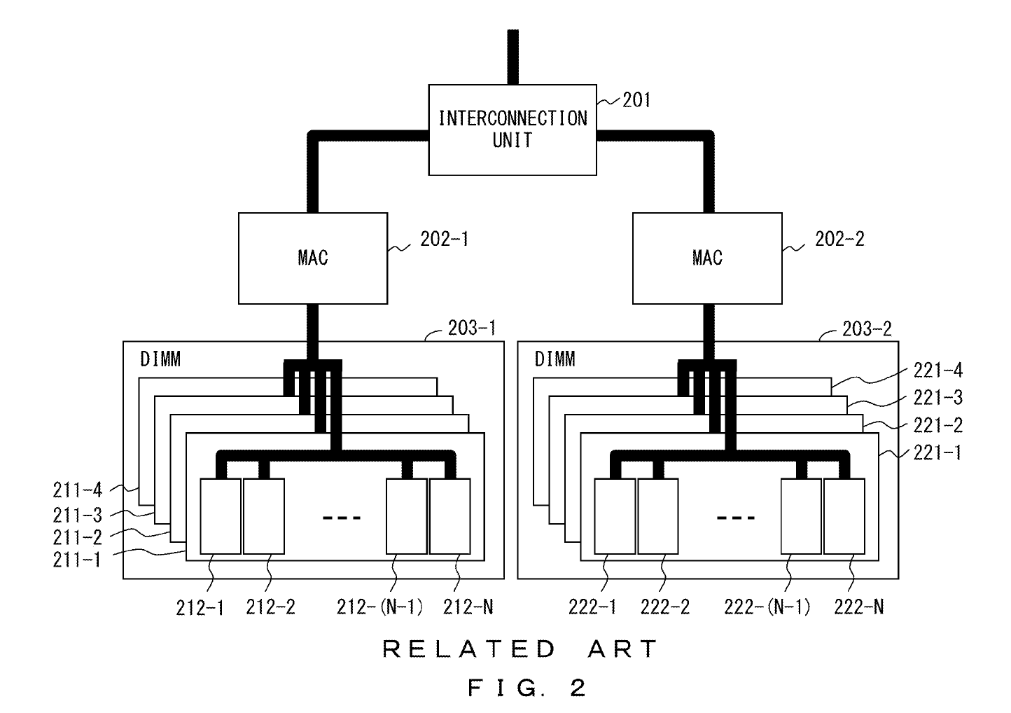

FIG. 3 illustrates first command issuance intervals in the closed page mode;

FIG. 4 illustrates second command issuance intervals in the closed page mode;

FIG. 5 illustrates a configuration of a memory control device;

FIG. 6 is a flowchart of first memory access control;

FIG. 7 illustrates a configuration of a server;

FIG. 8 illustrates an embodiment of a memory mirroring configuration that uses a single MAC;

FIG. 9 illustrates a configuration of an address decoder;

FIG. 10 is a flowchart of second memory access control;

FIG. 11 illustrates an embodiment of a memory mirroring configuration that uses two MACs;

FIG. 12 illustrates a configuration of an interconnection unit;

FIG. 13 is a flowchart of third memory access control; and

FIG. 14 illustrates third command issuance intervals in the closed page mode.

### DESCRIPTION OF EMBODIMENTS

Hereinafter, the embodiments will be explained in detail by referring to the drawings.

In a conventional memory mirroring configuration that uses a single MAC, when the MAC has received a plurality of read requests, it continuously accesses one physical rank as long as there is not an uncorrectable error. In a conventional memory mirroring configuration that uses two MACs, when the interconnection unit has received a plurality of read requests, it always transmits the read requests to both of the MACs. And both of the MACs make accesses to physical ranks that are connected respectively to them.

Also, in both of the memory mirroring configurations, using a single MAC and using two MACs, it is desirable that the limitation of tRC of DIMM be met when accesses are made to the same bank continuously in memory accesses based on the closed page mode. tRC is a limitation that defines time intervals between issuance of an active command to a bank of a DIMM from a MAC and another issuance of an active command to the same bank. Also in the open page mode, it is desirable that the limitation of tRC be met when page misses occur continuously in memory accesses to the same bank.

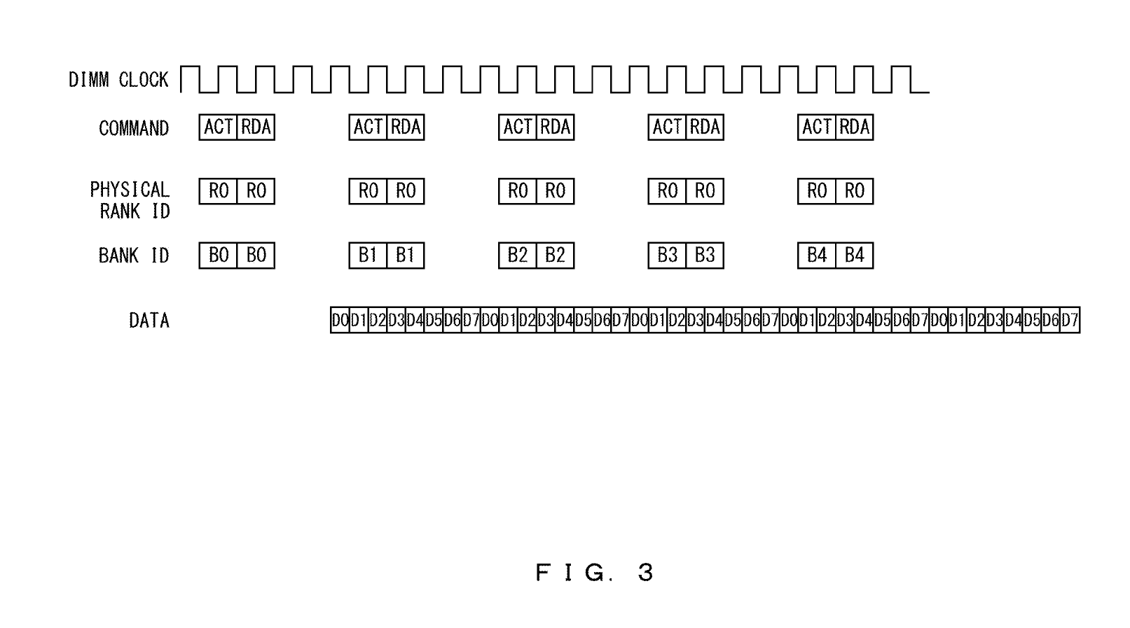

FIG. 3 illustrates command issuance intervals in a case when read accesses are made to different banks in the closed page mode. In FIG. 3, “DIMM clock” represents an operation clock signal of a DIMM, “command” represents a command issued to the DIMM from the MAC. “ACT” represents an active command, and “RDA” represents a read command that accompanies auto precharge.

“Physical rank ID” represents identification information of a physical rank output from the MAC to a DIMM, and “bank ID” represents bank identification information. “Data” represents READ data read from the bank corresponding to a bank ID in the physical rank specified by a physical rank ID.

In such a case, active commands “ACT” are issued to the respective banks corresponding to bank IDs “B0” through “B4” at short time intervals without being influenced by the tRC limitation.

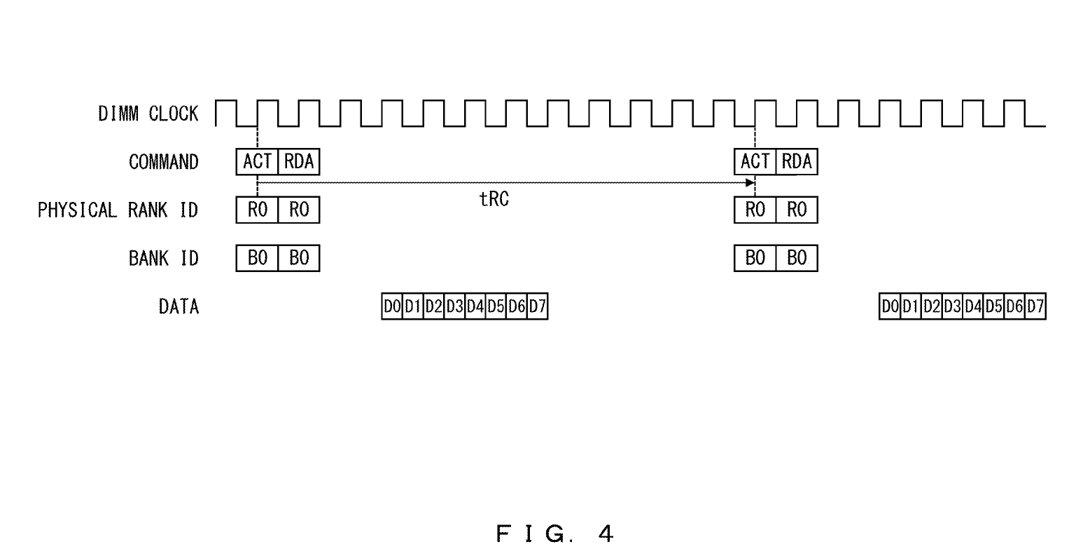

FIG. 4 illustrates command issuance intervals in a case when read accesses are continuously made to the same bank in the closed page mode. In such a case, active commands “ACT” are issued to a particular bank that corresponds to bank ID “B0” at time intervals defined by tRC. Because read accesses to the same bank are influenced by the tRC limitation as described above, intervals of issuing active commands become longer, leading to longer random access cycles, which is problematic.

In recent Double Data Rate 3 SDRAMs (DDR3 SDRAMs), for example, tRC is set to be approximately 30 cycles in terms of the DIMM clock. Accordingly, when accesses are made to the same bank continuously, the intervals of issuing active commands become approximately 30 cycles. Because one access occupies the data bus for four cycles, the data bus is used only for four cycles out of thirty four cycles. Accordingly, when all accesses made in the closed page mode are assumed to be made to the same bank, the use efficiency of the bus decreases to approximately one eighth.

Because read accesses to the same bank are influenced by the tRC limitation as described above, intervals of issuing active commands becomes longer, leading to a decrease in the use efficiency of the bus, which is problematic.

Also, the above problems occur not only in information processing apparatuses including a DIMM divided into a plurality of physical ranks, but also in information processing apparatuses having a memory divided into a plurality of units of operation, which are different from physical ranks.

Accordingly, it is desired that the use efficiency of a bus be improved when read accesses based on the same bank identification information occur continuously in a memory mirroring configuration.

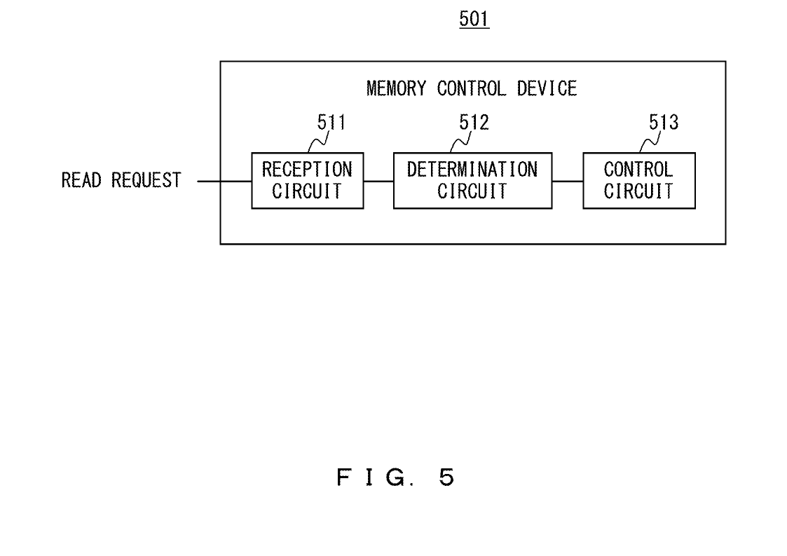

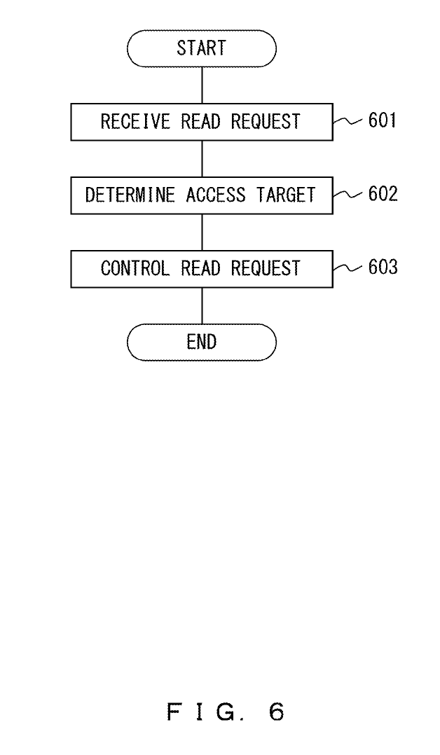

FIG. 5 illustrates a hardware configuration example of a memory control device 501 according to an embodiment. FIG. 6 is a flowchart illustrating an example of memory access control performed by the memory control device 501.

The memory control device 501 illustrated in FIG. 5 includes a reception circuit 511, a determination circuit 512, and a control circuit 513, and controls accesses to a memory that has been divided into a plurality of units of operation. The first and second units of operation from among the above plurality of units of operation constitute a memory mirror.

The reception circuit 511 receives a plurality of read requests including bank identification information corresponding to both a first bank and a second bank that are included in the first and second units of operation, respectively (step 601).

The determination circuit 512 determines the access target for each read access so that a plurality of read accesses based on the above plurality of read requests are made to the first and second units of operation alternately (step 602).

The control circuit 513 controls each read request so that each read access is made to the unit of operation determined as the access target (step 603).

According to the memory control device 501 of the above configuration, the use efficiency of a bus can be improved when read accesses based on the same bank identification information occur continuously in a memory mirroring configuration.

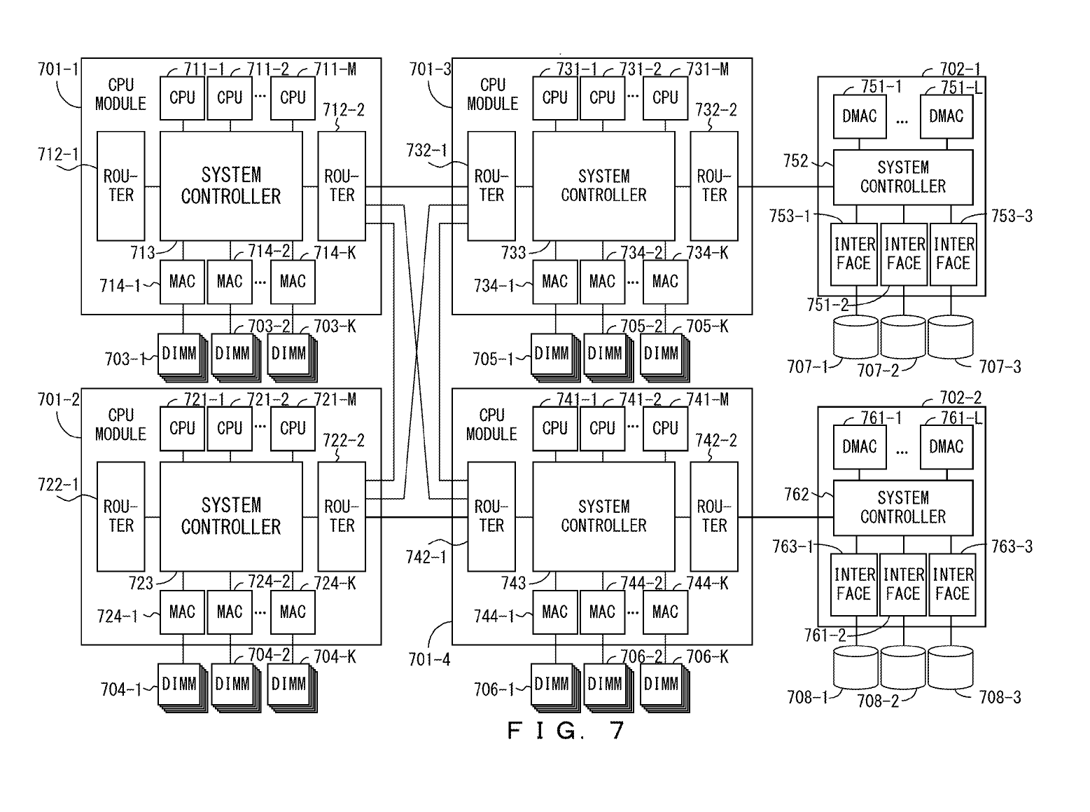

FIG. 7 illustrates a hardware configuration example of a server, which is an information processing apparatus (computer) including the memory control device 501 illustrated in FIG. 5. The server in FIG. 7 includes Central Processing Unit (CPU) modules 701-1 through 701-4 and input/output (I/O) controllers 702-1 and 702-2.

The server in FIG. 7 includes DIMMs 703-1 through 703-K (K is a positive integer), DIMMs 704-1 through 704-K, DIMMs 705-1 through 705-K, and DIMMs 706-1 through 706-K. Each “DIMM 703-i” (i=1 through K) represents one or more DIMMs. This is applied also to “DIMM704-i”, “DIMM705-i”, and “DIMM706-i”.

The server in FIG. 7 also includes devices 707-1 through 707-3 and devices 708-1 through 708-3. The devices 707-1 through 707-3 and 708-1 through 708-3 are, for example, harddisk drives, I/O devices, and the like.

The CPU module 707-1 includes CPUs (processors) 711-1 through 711-M (M is a positive integer), routers 712-1 and 712-2, a system controller 713, and MACs 714-1 through 714-K. The system controller 713 includes Last Level Cache (LLC). The DIMMs 703-1 through 703-K are connected to the MACs 714-1 through 714-K, respectively.

The CPU module 701-2 includes CPUs 721-1 through 721-M, routers 722-1 and 722-2, a system controller 723, and MACs 724-1 through 724-K. The system controller 723 includes LLC. The DIMMs704-1 through 704-K are connected to the MACs 724-1 through 724-K, respectively.

The CPU module 701-3 includes CPUs 731-1 through 731-M, routers 732-1 and 732-2, a system controller 733, and MACs 734-1 through 734-K. The system controller 733 includes LLC. The DIMMs 705-1 through 705-K are connected to the MACs 734-1 through 734-K, respectively.

The CPU module 701-4 includes CPUs 741-1 through 741-M, routers 742-1 and 742-2, a system controller 743, and MACs 744-1 through 744-K. The system controller 743 includes LLC. The DIMMs 706-1 through 706-K are connected to the MACs 744-1 through 744-K, respectively.

The I/O controller 702-1 includes Direct Memory Access Controllers (DMACs) 751-1 through 751-L (L is a positive integer) and a system controller 752. The I/O controller 702-1 also includes interfaces 753-1 through 753-3. The devices 707-1 through 707-3 are connected to the interfaces 753-1 through 753-3, respectively.

The I/O controller 702-2 includes DMACs 761-1 through 761-L, a system controller 762, and interfaces 763-1 through 763-3. The devices 708-1 through 708-3 are connected to the interfaces 763-1 through 763-3, respectively.

The routers 712-2, 722-2, 732-1, and 742-1 are connected to each other, and CPU modules 701-1 through 701-4 can communicate with each other. Also, the router 732-2 and the system controller 752 are connected, and the CPU module 701-3 and the I/O controller 702-1 can communicate with each other. Similarly, the router 742-2 and the system controller 762 are connected, and the CPU module 701-4 and the I/O controller 702-2 can communicate with each other.

In a memory mirroring configuration using a single MAC, each of the MACs 714-i, 724-i, 734-i, and 744-i (i=1 through K) corresponds to the memory control device 501 illustrated in FIG. 5. Each MAC receives a memory access request as, for example, described below, and controls accesses to DIMMs.

(1) A memory access request made by a CPU as the requesting source in the same CPU module

(2) A memory access request made by a CPU as the requesting source in a different CPU module

(3) A memory access request made by a DMAC as the requesting source in an I/O controller

In some cases, the MAC 714-1 in the CPU module 701-1, for example, receives a memory access request as described below.

(1) Memory access requests made by the CPUs 721-1 through 721-M in the CPU module 701-2

(2) Memory access requests made by the CPUs 731-1 through 731-M in the CPU module 701-3

(3) Memory access requests made by the CPUs 741-1 through 741-M in the CPU module 701-4

(4) Memory access requests made by the DMACs 751-1 through 751-L in the I/O controller 702-1

(5) Memory access requests made by the DMACs 761-1 through 761-L in the I/O controller 702-2

Note that the number of CPU modules is not limited to four, and may be an integer equal to or greater than one. The number of I/O controllers is not limited to two, and may be an integer equal to or greater than one. Also, the number of devices connected to I/O controllers is not limited to three, and may be an integer equal to or greater than one.

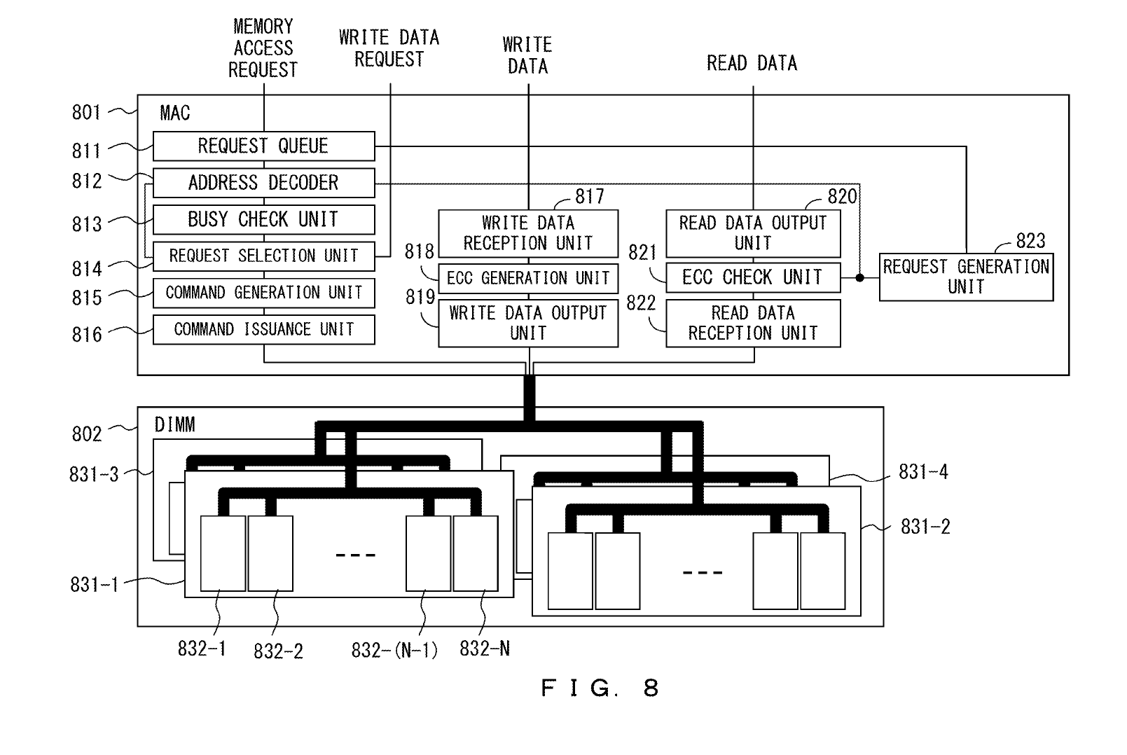

Next, by referring to FIGS. 8 through 10, explanations will be given for configurations and operations of a MAC in a case when a memory mirroring configuration using a single MAC has been employed in the server illustrated in FIG. 7.

The memory mirroring configuration in FIG. 8 includes a MAC 801 and a DIMM 802. The MAC 801 corresponds to each of the MACS 714-i, 724-i, 734-i, and 744-i (i=1 through K) illustrated in FIG. 7. The DIMM 802 corresponds to each of the DIMMs 703-i, 704-i, 705-i, and 706-i (i=1 through K) illustrated in FIG. 7.

The MAC 801 includes a request queue 811, an address decoder 812, a busy check unit 813, a request selection unit 814, a command generation unit 815, and a command issuance unit 816. The MAC 801 also includes a WRITE data reception unit 817, an Error Correcting Code (ECC) generation unit 818, a WRITE data output unit 819, a READ data output unit 820, an ECC check unit 821, a READ data reception unit 822, and a request generation unit 823.

The DIMM 802 includes physical ranks 831-1 through 831-4. Among them, the physical ranks 831-1 and 831-2 are of a pair that constitutes a memory mirror, and the physical ranks 831-3 and 831-4 are of another pair that constitutes the memory mirror.

The physical rank 831-1 includes banks 832-1 through 832-N (N is an integer equal to or greater than 1), and each of the physical ranks 831-2 through 831-4 also includes N banks similarly to the physical rank 831-1. Also, the number of physical ranks is not limited to four, and may be an even number equal to or greater than two.

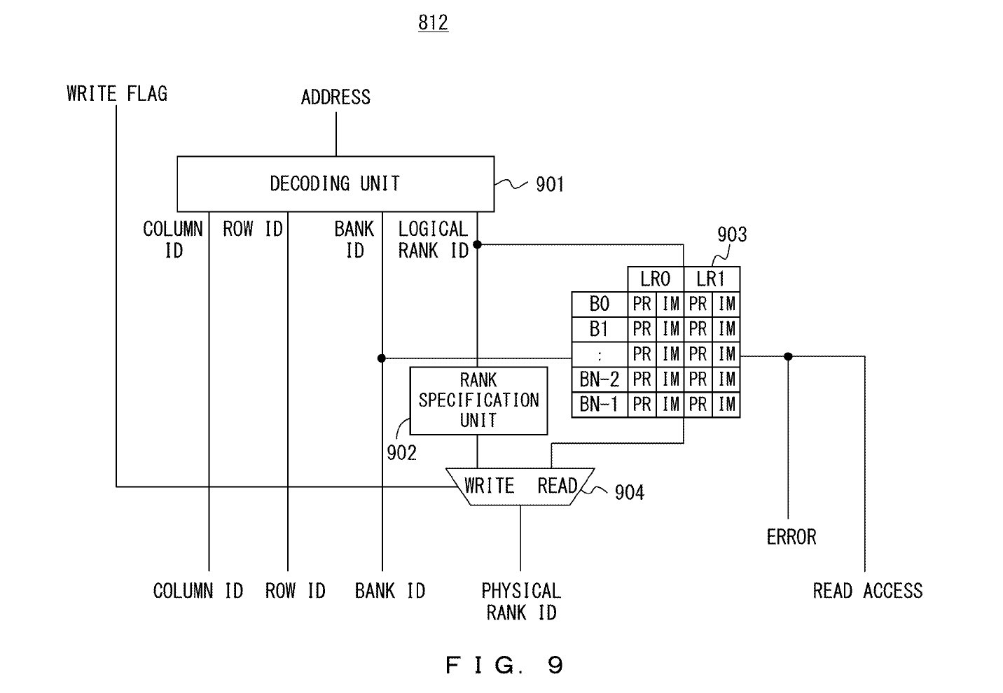

FIG. 9 illustrates a configuration example of the address decoder 812 illustrated in FIG. 8. The address decoder 812 illustrated in FIG. 9 includes a decoding unit 901, a rank specification unit 902, a rank table 903, and a selection unit 904.

The decoding unit 901 decodes the address included in a memory access request obtained from a requesting source, and generates a column ID, a row ID, a bank ID, and a logical rank ID. A column ID, a row ID, a bank ID, and a logical rank ID are pieces of identification information for a column, a row, a bank, and a logical rank. The decoding unit 901 outputs a bank ID to the rank table 903, and also outputs the logical rank ID to the rank specification unit 902 and the rank table 903.

The rank specification unit 902 generates two physical rank IDs, which are pieces of identification information of two physical ranks of a pair corresponding to a logical rank ID, and outputs these physical rank IDs to the selection unit 904.

Rank table 903 stores an entry for each combination between a bank ID and a logical rank ID. Each entry includes a PR, which is a physical rank ID, and update control information IM. “LR0” is a logical rank ID corresponding to the pair of the physical ranks 831-1 and 831-2, and “LR1” is a logical rank ID corresponding to the pair of the physical ranks 831-3 and 831-4. “B0” through “BN−1” are pieces of bank identification information for N banks in each of the physical ranks 831-i (i=1 through 4).

A PR is the ID of one of the two physical ranks of a pair that corresponds to a logical rank ID, and indicates a physical rank of an access destination for a read access. The rank table 903 outputs to the selection unit 904 the physical rank ID of an entry that corresponds to a combination of the bank ID and the logical rank ID output from the decoding unit 901.

Each time a read access based on the same combination of a bank ID and a logical rank ID is made, PR on the rank table 903 is updated to the physical rank ID of the other one of the physical ranks constituting the pair. Update control information IM is information indicating whether or not an updating of PR is permitted, and indicates the permission to update unless an uncorrectable error occurs in READ data.

When an uncorrectable error occurs in READ data in a read access, the PR corresponding to the combination of the bank ID and the logical rank ID is fixed to the physical rank ID of the other physical rank that constitutes a pair together with the physical rank in which the error has occurred. When this is performed, update control information IM is updated to information that prohibits updating so that the PR will not be updated in the future.

When the write flag included in a memory access request from a requesting source indicates a write access, the selection unit 904 selects and outputs two physical rank IDs from the rank specification unit 902. When the write flag does not indicate a write access, i.e., when it indicates a read access, the selection unit 904 selects and outputs a physical rank ID from the rank table 903.

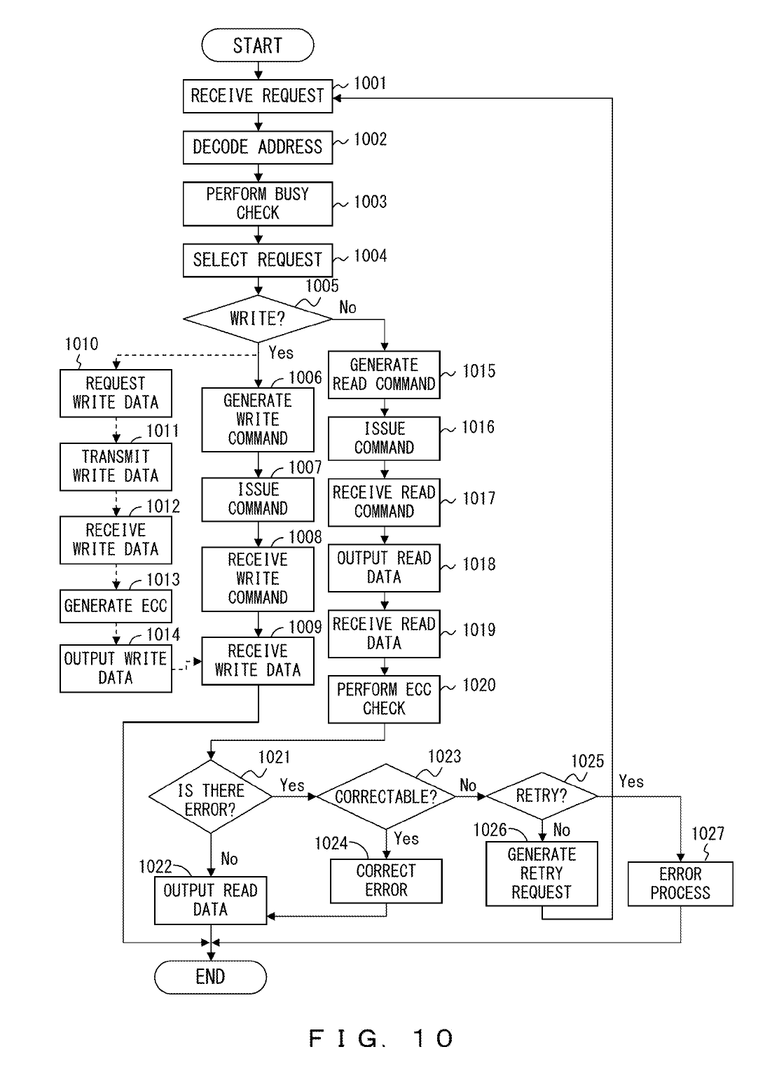

FIG. 10 is a flowchart illustrating an example of memory access control performed by the MAC 801 in FIG. 8.

First, the request queue 811 receives a memory access request from a requesting source (step 1001). Then, the address decoder 812 decodes the address included in the received memory access request, and generates access information used for accessing the DIMM 802 (step 1002). This access information includes a column ID, a row ID, a bank ID, and a physical rank ID. The access information includes two physical rank IDs for a write access and one physical rank ID for a read access.

Next, the busy check unit 813 checks whether or not the DIMM 802 is busy (step 103). When the DIMM 802 is not busy, the request selection unit 814 selects a memory access request having the highest priority from among a plurality of memory access requests in the request queue 811 (step 1004). The request selection unit 814 determines whether the selected memory access request is a write request or a read request on the basis of the write flag included in the selected memory access request (step 1005).

When the memory access request is a write request (YES in step 1005), the request selection unit 814 transmits a write data request to the requesting source (step 1010). Then, the requesting source transmits the WRITE data to the MAC 801 (step 1011).

The WRITE data reception unit 817 receives the WRITE data from the requesting source after a prescribed number of cycles elapsed after it transmitted a write data request (step 1012). The ECC generation unit 818 generates an ECC of the WRITE data (step 1013), and the WRITE data output unit 819 outputs to the DIMM 802 the WRITE data to which the ECC has been added (step 1014).

The command generation unit 815 generates a write command used for accessing the DIMM 802 (step 1006), and the command issuance unit 816 issues a write command to the DIMM 802 (step 1007). The command issuance unit 816 also outputs the access information to the DIMM 802.

The DIMM 802 receives the write command and the access information from the command issuance unit 816 (step 1008), and receives the WRITE data from the WRITE data output unit 819 (step 1009). Thereafter, the DIMM 802 stores the WRITE data in the access destination specified by the access information.

When the memory access request is a read request (NO in step 1005), the request selection unit 814 reports to the address decoder 812 that a read access will be made in accordance with the read request.

In accordance with this report, the address decoder 812 refers to the entry that corresponds to the combination of the bank ID and the logical rank ID output from the decoding unit 901 from among entries on the rank table 903. When update control information IM of that entry is indicating the permission to update, the address decoder 812 updates the PR of the entry to the physical rank ID of the other one of the physical ranks that constitute the pair. Thereby, a physical rank different from that of the access destination of the current read access is specified as the access destination of the next read access directed to the same combination of the bank ID and the logical rank ID.

As described above, each time a read access is made to the same combination of the bank ID and the logical rank ID, the physical rank ID of the access destination is updated, and thereby two physical ranks constituting a memory mirror receive read accesses alternately. Accordingly, the use efficiency of the bus can be improved when read accesses based on the same bank ID occur continuously in a memory mirroring configuration.

When update control information IM is indicating the prohibition to update, the address decoder 812 does not update the PR of the entry.

Next, the command generation unit 815 generates a read command used for accessing the DIMM 802 (step 1015), and the command issuance unit 816 issues a read command to the DIMM 802 (step 1016). The command issuance unit 816 also outputs the access information to the DIMM 802.

The DIMM 802 receives the read command and the access information from the command issuance unit 816 (step 1017), and outputs READ data to the MAC 801 after a prescribed number of cycles (step 1018).

The READ data reception unit 822 receives the READ data from the DIMM 802 (step 1019). Thereafter, the ECC check unit 821 checks whether or not the READ data is right on the basis of the ECC that has been added to the READ data (step 1020) so as to determine the presence or absence of an error (step 1021).

When there are no errors in the READ data (NO in step 1021), the READ data output unit 820 transmits the READ data to the requesting source (step 1022).

When there is an error in the READ data (YES in step 1021), the ECC check unit 821 checks whether or not that error is correctable (step 1023). When that error is correctable (YES instep 1023), the ECC check unit 821 corrects the error by using the ECC (step 1024), and the READ data output unit 820 transmits the corrected READ data to the requesting source (step 1022).

When the error is an uncorrectable error (NO in step 1023), the ECC check unit 821 checks whether or not the read request is a retry request (step 1025). A retry request is a request requiring that when an uncorrectable error has occurred in READ data, a read access be made to the other one of the physical ranks constituting the pair.

When the read request is not a retry request (NO in step 1025), the ECC check unit 821 reports to the address decoder 812 and the request generation unit 823 that an uncorrectable error has occurred in READ data.

In accordance with this report, the address decoder 812 refers to the entry that corresponds to the combination of the bank ID and the logical rank ID output from the decoding unit 901 from among entries on the rank table 903. Then, the address decoder 812 updates update control information IM of that entry to information indicating the prohibition to update. Thereby, the PR of that entry is fixed to the physical rank ID of the other physical rank that constitutes a pair together with the physical rank in which the error has occurred, so that the use of the physical rank in which the error has occurred is prohibited.

Also, the request generation unit 823 outputs a retry request of the read access to the request queue 811 in accordance with the report that an uncorrectable error has occurred (step 1026). Thereby, the operations in and subsequent to step 1001 are restarted, and a read access is made to the physical rank other than the physical rank that has been prohibited from being used.

When the read request is a retry request (YES in step 1025), the ECC check unit 821 performs an error process (step 1027). In such a case, the MAC 801 halts the operation because an uncorrectable error occurred in both of the two physical ranks corresponding to the logical rank ID of the read request.

The configurations of the MAC 801 and the address decoder 812 illustrated in FIG. 8 and FIG. 9 are just exemplary, and part of the constituent elements may be omitted or altered in accordance with processes performed by the MAC 801. For example, when the check of READ data based on an ECC is not performed, the ECC generation unit 818, the ECC check unit 821, and the request generation unit 823 illustrated in FIG. 8 may be omitted.

Note that the flowchart in FIG. 10 is just exemplary, and some of the processes may be omitted or altered in accordance with the configurations or conditions of the MAC 801. For example, when the check of READ data based on an ECC is not performed, the processes insteps 1013, 1020, 1021, and 1023 through 1027 in FIG. 10 may be omitted.

Next, explanations will be given for a configuration and operations of the interconnection unit in a case when a memory mirroring configuration using two MACs in the server in FIG. 7 is employed.

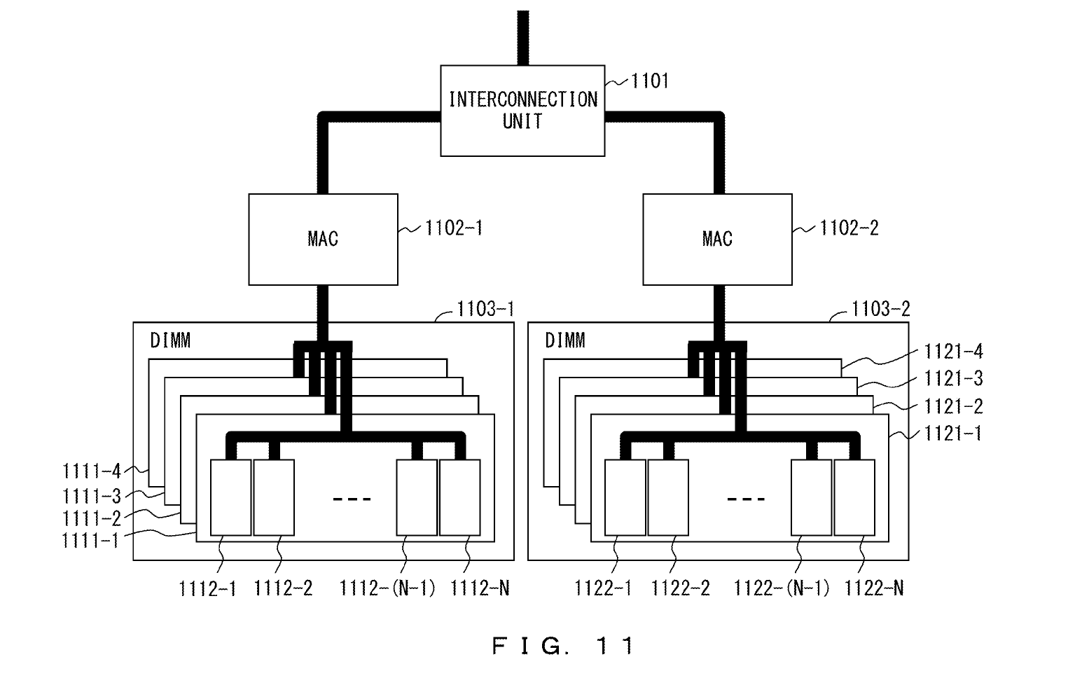

The memory mirroring configuration illustrated in FIG. 11 includes an interconnection unit 1101, MACs 1102-1 and 1102-2, and DIMMs 1103-1 and 1103-2. The MACs 1102-1 and 1102-2 correspond to any two of the following MACs.

(1) Two MACs from among the MACs 714-1 through 714-K illustrated in FIG. 7

(2) Two MACs from among the MACs 724-1 through 724-K illustrated in FIG. 7

(3) Two MACs from among the MACs 734-1 through 734-K illustrated in FIG. 7

(4) Two MACs from among the MACs 744-1 through 744-K illustrated in FIG. 7

Also, the DIMMs 1103-1 and 1103-2 correspond to any two of the following DIMMs.

(1) Two DIMMs from among the DIMMs 703-1 through 703-K illustrated in FIG. 7

(2) Two DIMMs from among the DIMMs 704-1 through 704-K illustrated in FIG. 7

(3) Two DIMMs from among the DIMMs 705-1 through 705-K illustrated in FIG. 7

(4) Two DIMMs from among the DIMMs 706-1 through 706-K illustrated in FIG. 7

In such a case, the interconnection unit 1101 is provided in the system controller 713, the system controller 723, the system controller 733, or the system controller 743 in FIG. 7. In a memory mirroring configuration using two MACs, the interconnection unit 1101 corresponds to the memory control device 501 illustrated in FIG. 5.

The DIMM 1103-1 includes physical ranks 1111-1 through 1111-4, and the DIMM 1103-2 includes physical ranks 1121-1 through 1121-4. Among them, the physical rank 1111-i (i=1 through 4) and the physical rank 1121-i are of a pair that constitutes the memory mirror. In this case, the MACs 1102-1 and 1102-2 also operate as a pair that constitutes the memory mirror.

The physical rank 1111-1 includes banks 1112-1 through 1112-N (N is an integer equal to or greater than 1), and each of the physical ranks 1111-2 through 1111-4 also includes N banks similarly to the physical rank 1111-1. The physical rank 1121-1 includes banks 1122-1 through 1122-N, and each of the physical ranks 1121-2 through 1121-4 also includes N banks similarly to the physical rank 1121-1. Note that the number of physical ranks in each DIMM is not limited to four, and may be an integer equal to or greater than one.

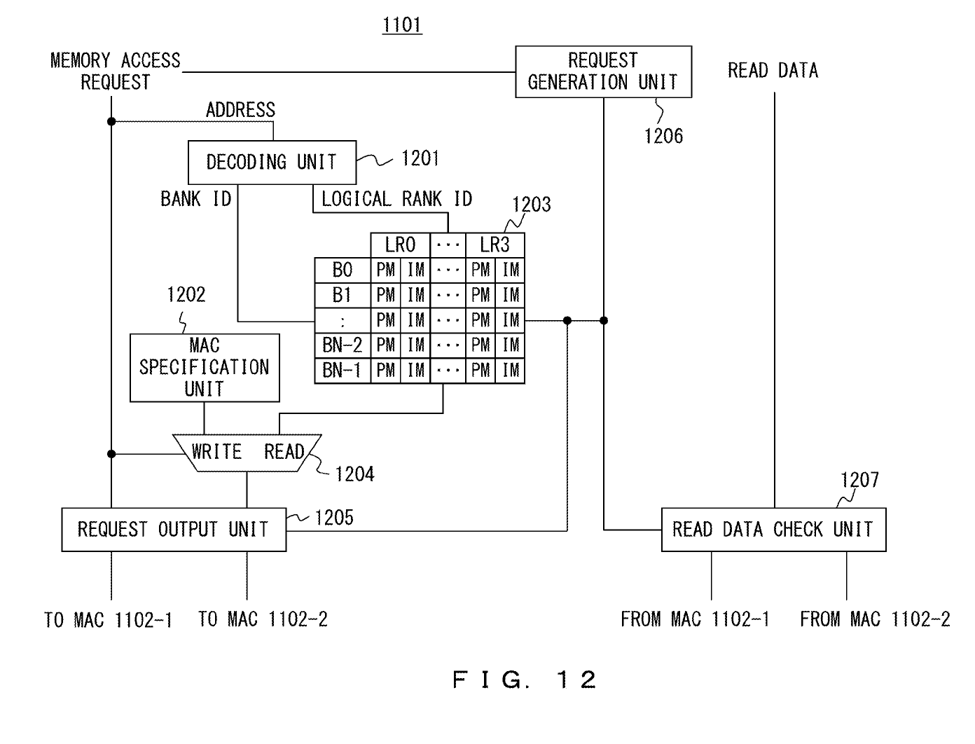

FIG. 12 illustrates a configuration example of the interconnection unit 1101 illustrated in FIG. 11. The interconnection unit 1101 illustrated in FIG. 12 includes a decoding unit 1201, a MAC specification unit 1202, a MAC table 1203, a selection unit 1204, a request output unit 1205, a request generation unit 1206, and a READ data check unit 1207.

The decoding unit 1201 decodes the address included in a memory access request from a requesting source, and generates a bank ID and a logical rank ID. The decoding unit 1201 outputs the bank ID and the logical rank ID to the MAC table 1203.

The MAC specification unit 1202 generates MAC identification information for the MACs 1102-1 and 1102-2, and outputs these pieces of the MAC identification information to the selection unit 1204. The MAC identification information of the MAC 1102-1 is MAC0, and the MAC identification information of the MAC 1102-2 is MAC1.

The MAC table 1203 stores an entry for each combination of a bank ID and a logical rank ID. Each entry includes a PM, which is MAC identification information, and update control information IM.

“LR0” is a logical rank ID corresponding to a pair of the physical ranks 1111-1 and 1121-1, and “LR1” is a logical rank ID corresponding to a pair of the physical ranks 1111-2 and 1121-2. “LR2” is a logical rank ID corresponding to a pair of the physical ranks 1111-3 and 1121-3. “LR3” is a logical rank ID corresponding to a pair of the physical ranks 1111-4 and 1121-4. “B0” through “BN−1” are pieces of bank identification information of N banks included in each of the physical ranks 1111-i and 1121-i (i=1 through 4).

A PM is MAC identification information of one of the MACs 1102-1 and 1102-2, and indicates a MAC that is an access destination for a read access. The MAC table 1203 outputs to the selection unit 1204 the MAC identification information of the entry that corresponds to the combination of the bank ID and the logical rank ID output from the decoding unit 1201.

Each PM on the MAC table 1203 is updated to the MAC identification information of the other one of the MACs that constitute the pair each time a read access is made to the same combination of a bank ID and a logical rank ID. Update control information IM is information indicating whether or not an updating of PMs is permitted, and indicates the permission to update unless an uncorrectable error occurs in READ data.

When the write flag included in a memory access request from a requesting source indicates a write access, the selection unit 1204 selects and outputs two pieces of MAC identification information from the MAC specification unit 1202. When the write flag does not indicate a write access, i.e., when it indicates a read access, the selection unit 1204 selects and outputs MAC identification information from the MAC table 1203.

The request output unit 1205 outputs a memory access request from a requesting source to a MAC specified by one or two pieces of MAC identification information output from the selection unit 1204. Accordingly, a write request is output to both of the MACs 1102-1 and 1102-2, and a read request is output to one of the MACs 1102-1 and 1102-2.

The READ data check unit 1207 receives, from the MAC 1102-1 or the MAC 1102-2, READ data and determination information indicating whether or not the READ data is normal. A case where READ data is normal corresponds to a case where no errors occurred in the READ data or a case where an error that occurred in the READ data has been corrected. A case where READ data is not normal corresponds to a case where an uncorrectable error occurred in the READ data.

When the received determination information indicates that the READ data is normal, the READ data check unit 1207 transmits the received READ data to the requesting source.

When the received determination information indicates that the READ data is not normal, the READ data check unit 1207 updates the update control information IM of the corresponding entry on the MAC table 1203 to information that prohibits updating. Thereby, the PM of that entry is fixed to the MAC identification information of the MAC connected to the other physical rank that constitutes a pair together with the physical rank in which the error has occurred.

The READ data check unit 1207 reports to the request generation unit 1206 that the READ data is not normal. The request generation unit 1206 generates a retry request in accordance with this report.

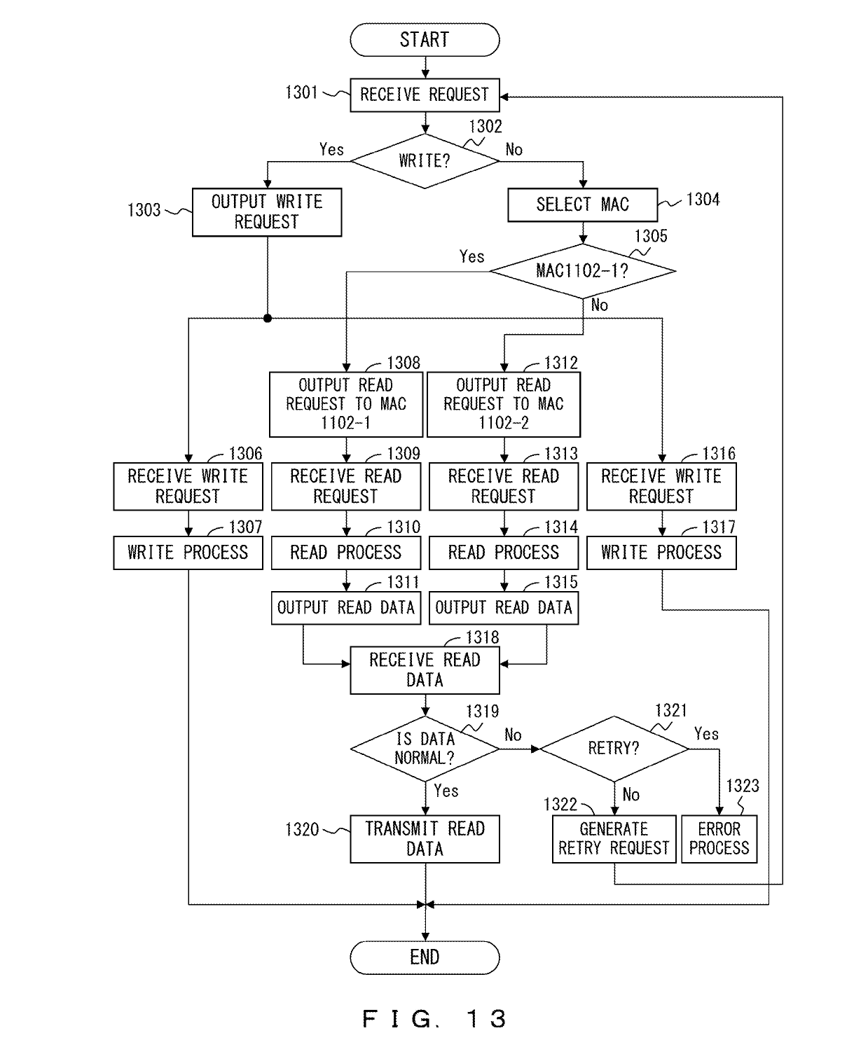

FIG. 13 is a flowchart illustrating an example of memory access control performed by the interconnection unit 1101 and the MACs 1102-1 and 1102-2 illustrated in FIG. 11.

First, the interconnection unit 1101 receives a memory access request from a requesting source (step 1301). The decoding unit 1201 decodes the address included in the received memory access request, and generates a bank ID and a logical rank ID. The MAC table 1203 outputs to the selection unit 1204 the MAC identification information of the entry that corresponds to the combination of the generated bank ID and the logical rank ID.

The selection unit 1204 determines whether the request is a write request or a read request on the basis of the write flag included in the received memory access request (step 1302).

When the memory access request is a write request (YES in step 1302), the selection unit 1204 outputs, to the request output unit 1205, the MAC identification information of the MACs 1102-1 and 1102-2 output from the MAC specification unit 1202. When the memory access request is a read request (NO in step 1302), the selection unit 1204 outputs, to the request output unit 1205, the MAC identification information output from the MAC table 1203.

When the memory access request is a write request (YES in step 1302), the request output unit 1205 outputs that write request to both of the MACs 1102-1 and 1102-2 (step 1303).

The MAC 1102-1 receives the write request from the request output unit 1205 (step 1306), and performs a write process (step 1307). The procedures in a write process are similar to those in steps 1006 through 1014 in FIG. 10.

In this write process, the MAC 1102-1 transmits a write data request to the requesting source, and receives WRITE data from the requesting source. Next, the MAC 1102-1 generates an ECC for the WRITE data, and outputs to the DIMM 1103-1 WRITE data to which the ECC has been added. The MAC 1102-1 generates a write command, and issues that write command to the DIMM 1103-1. The DIMM 1103-1 stores the WRITE data in accordance with the write command.

The MAC 1102-2 receives the write request from the request output unit 1205 (step 1316), and performs a write process (step 1317). The procedure in the write process is similar to that in step 1307.

When the memory access request is a read request (NO in step 1302), the request output unit 1205 selects a MAC in accordance with MAC identification information output from the selection unit 1204 (step 1304). Then, the request output unit 1205 checks whether the MAC identification information indicates the MAC 1102-1 or the MAC 1102-2 (step 1305).

When the MAC identification information is indicating the MAC 1102-1, the request output unit 1205 outputs the read request to the MAC 1102-1 (step 1308). The MAC 1102-1 receives the read request from the request output unit 1205 (step 1309), and performs a read process (step 1310). The procedures of a read process are similar to those in steps 1015 through 1021 and steps 1023 through 1024 in FIG. 10.

In this read process, the MAC 1102-1 generates a read command, and issues that read command to the DIMM 1103-1. The DIMM 1103-1 outputs READ data to the MAC 1102-1 in accordance with the read command.

The MAC 1102-1 determines whether or not there are read errors in the READ data on the basis of the ECC added to the READ data. When there are no read errors, the MAC 1102-1 outputs, to the interconnection unit 1101, the READ data and determination information indicating that the READ data is normal (step 1311).

When there is an error in the READ data, the MAC 1102-1 checks whether or not that error is correctable, and, when that error is correctable, corrects the error by using the ECC. Thereafter, the MAC 1102-1 outputs, to the interconnection unit 1101, the corrected READ data and determination information indicating that the READ data is normal.

When the error is an uncorrectable error, the MAC 1102-1 outputs, to the interconnection unit 1101, the READ data and determination information indicating that the READ data is not normal (step 1311).

When MAC identification information indicates the MAC 1102-2, the request output unit 1205 outputs the read request to the MAC 1102-2 (step 1312). The MAC 1102-2 receives the read request from the request output unit 1205 (step 1313), and performs a read process (step 1314). The procedure of a read process is similar to that insteps 1310. The MAC 1102-2 outputs, to the interconnection unit 1101, the READ data and determination information indicating whether or not the READ data is normal (step 1315).

When the request output unit 1205 has output a read request to the MAC 1102-1 or 1102-2, it refers to an entry corresponding to the combination of the bank ID and the logical rank ID output from the decoding unit 1201 from among entries on the MAC table 1203. When the update control information IM of that entry is indicating the permission to update, the request output unit 1205 updates the PM of that entry to the MAC identification information of the MAC that is connected to the other of the physical ranks constituting the pair. Thereby, a MAC that is different from the output destination of the current read access is specified as the output destination of the next read access made to the same combination of the bank ID and the logical rank ID.

As described above, each time a read access is made to the same combination of the bank ID and the logical rank ID, the MAC identification information of the output destination is updated so that read accesses are output alternately to the two MACs that constitutes a pair. Thereby, read accesses are alternately made to two physical ranks that constitute a memory mirror. Accordingly, the use efficiency of a bus can be improved when read accesses based on the same bank ID occur continuously in a memory mirroring configuration.

When the update control information IM is indicating the prohibition to update, the request output unit 1205 does not update the PR of that entry.

The READ data check unit 1207 receives READ data and the determination information from the MAC 1102-1 or 1102-2 (step 1318), and checks the received determination information (step 1319). When the determination information is indicating that the READ data is normal (YES in step 1319), the READ data check unit 1207 transmits the received READ data to the requesting source (step 1320).

When the determination information is indicating that the READ data is not normal, the READ data check unit 1207 checks whether or not the read request is a retry request (step 1321).

When the read request is not a retry request (NO in step 1321), the READ data check unit 1207 refers to the entry that corresponds to the combination of the bank ID and the logical rank ID output from the decoding unit 1201, from among entries on the MAC table 1203. Then, the READ data check unit 1207 updates the update control information IM of that entry to information indicating the prohibition to update. Thereby, the PM of that entry is fixed to the MAC identification information of the MAC connected to the other physical rank that constitutes a pair together with the physical rank in which the error has occurred, and the use of the MAC connected to the physical rank in which the error has occurred is prohibited.

The READ data check unit 1207 reports, to the request generation unit 1206, that the READ data is not normal (step 1302). On the basis of this report, the request generation unit 1206 generates a retry request of the read access. Thereby, the operations in and subsequent to step 1301 are restarted, and a read request to the MAC other than the MAC the use of which has been prohibited is output.

When a read request is a retry request (YES in step 1321), the READ data check unit 1207 performs an error process (step 1323). In this case, uncorrectable errors have occurred in both of the two physical ranks that correspond to the logical rank ID of the read request, and accordingly, the operation of the interconnection unit 1101 is halted.

The configuration of the interconnection unit 1101 illustrated in FIG. 12 is just exemplary, and part of the constituent elements may be omitted or altered in accordance with the processes performed by the interconnection unit 1101. For example, when the check of READ data based on an ECC is not performed, the request generation unit 1206 and the READ data check unit 1207 illustrated in FIG. 12 may be omitted.

Also, the flowchart of FIG. 13 is just exemplary, and some of the processes may be omitted or altered in accordance with the configurations or conditions of the interconnection unit 1101. For example, when the check of READ data based on an ECC is not performed, processes in steps 1319 and 1321 through 1323 in FIG. 13 may be omitted.

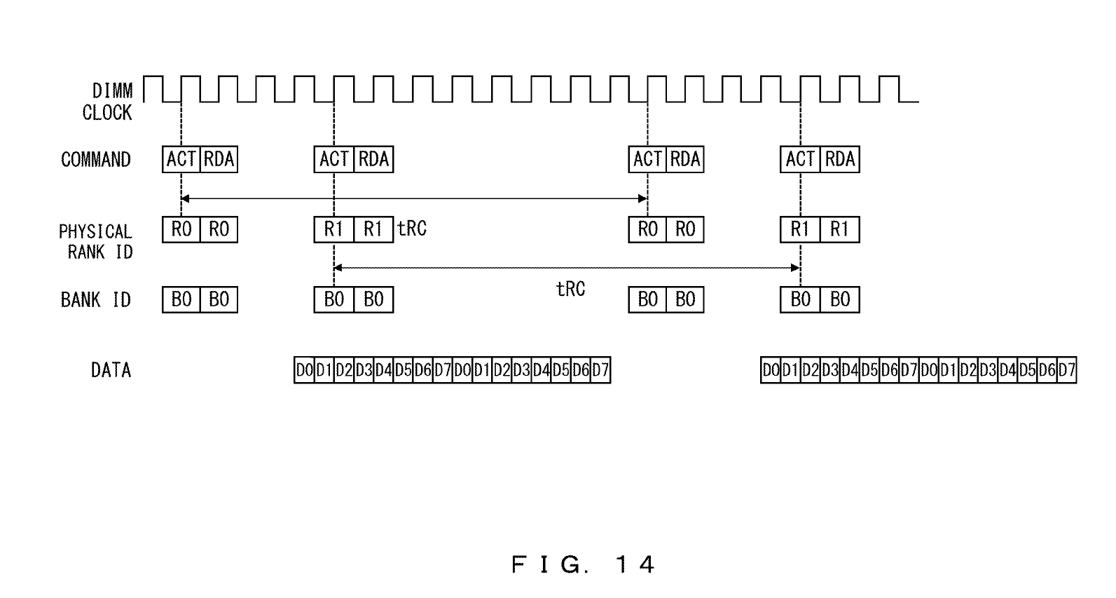

FIG. 14 illustrates command issuance intervals in a case when read accesses are continuously made to the same bank in the closed page mode in the memory mirroring configurations illustrated in FIG. 8 and FIG. 11. “R0” and “R1” are physical rank IDs of two physical ranks that constitute a memory mirror.

In this case, active commands “ACT” are issued to a particular bank that corresponds to bank ID “B0” in the same physical rank corresponding to “R0” or “R1” at time intervals defined by tRC. However, active commands “ACT” accompanying identical bank IDs “B0” are issued alternately to the physical ranks that correspond to “R0” and “R1”.

This makes it possible to apparently issue active commands “ACT” to the same bank once in about the half of the time interval defined by tRC, improving the use efficiency of a bus to approximately twice that of the case illustrated in FIG. 4. Thereby, the apparent random access cycle in a read access can be reduced to approximately half.

Also in the case of the open page mode, the memory mirroring configurations illustrated in FIG. 8 and FIG. 11 can improve the use efficiency of a bus when read accesses are continuously made to the same banks.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A memory control device that controls an access to a memory divided into a plurality of units of operation, the memory control device comprising:
a reception circuit configured to receive a plurality of read requests including bank identification information that corresponds to both a first bank included in a first unit of operation and a second bank included in a second unit of operation when the first unit of operation and the second unit of operation from among the plurality of units of operation constitute a memory mirror;
a determination circuit configured to determine an access target of each read access so that a plurality of read accesses based on the plurality of read requests are made to the first unit of operation and the second unit of operation alternately; and
a control circuit configured to control each read request so that each read access is made to a unit of operation determined as the access target.

2. The memory control device according to claim 1, wherein:
the control circuit issues a read command based on each read request to the unit of operation determined as the access target.

3. The memory control device according to claim 2, wherein:
the first unit of operation and the second unit of operation are a first physical rank and a second physical rank, respectively;
each of the plurality of read requests includes the bank identification information and logical rank identification information corresponding to the first physical rank and the second physical rank;
the determination circuit includes a table that stores physical rank identification information corresponding to a combination of the bank identification information and the logical rank identification information, and determines, as the access target, a physical rank indicated by the physical rank identification information output from the table on the basis of a combination of the bank identification information and the logical rank identification information included in each read request from among the first physical rank and the second physical rank; and
the control circuit updates the physical rank identification information on the table to physical rank identification information indicating a physical rank that is different from the physical rank determined as the access target from among the first physical rank and the second physical rank each time the read command based on each read request is issued to the physical rank determined as the access target.

4. The memory control device according to claim 3, wherein:
the control circuit fixes the physical rank identification information on the table to physical rank identification information indicating a physical rank different from a physical rank in which an uncorrectable error occurred from among the first physical rank and the second physical rank when read data output from the physical rank determined as the access target includes the uncorrectable error.

5. The memory control device according to claim 1, wherein:
the control circuit outputs each read request to a memory access controller that controls an access to the unit of operation determined as the access target from among a first memory access controller that controls an access to the first unit of operation and a second memory access controller that controls an access to the second unit of operation.

6. The memory control device according to claim 5, wherein:
the first unit of operation and the second unit of operation are a first physical rank and a second physical rank, respectively;
each of the plurality of read requests includes the bank identification information and logical rank identification information corresponding to the first physical rank and the second physical rank;
the determination circuit includes a table that stores memory access controller identification information corresponding to a combination of the bank identification information and the logical rank identification information, and determines, as the access target, a physical rank connected to a memory access controller indicated by the memory access controller identification information output from the table on the basis of a combination of the bank identification information and the logical rank identification information included in each read request from among the first physical rank and the second physical rank; and
the control circuit updates the memory access controller identification information on the table to memory access controller identification information indicating a memory access controller connected to a physical rank that is different from the physical rank determined as the access target from among the first memory access controller and the second memory access controller each time each read request is output to a memory access controller that controls an access to the physical rank determined as the access target.

7. The memory control device according to claim 6, wherein:
the control circuit fixes the memory access controller identification information on the table to memory access controller identification information indicating a memory access controller connected to a physical rank different from a physical rank in which an uncorrectable error occurred from among the first memory access controller and the second memory access controller when read data output from the physical rank determined as the access target includes the uncorrectable error.

8. An information processing apparatus, comprising:
a memory divided into a plurality of units of operation;
a requesting source configured to output a plurality of read requests including bank identification information corresponding to both a first bank included in a first unit of operation and a second bank included in a second unit of operation when the first unit of operation and the second unit of operation from among the plurality of units of operation constitute a memory mirror; and
a memory control device configured to control the plurality of read requests so that a plurality of read accesses based on the plurality of read requests are made to the first unit of operation and the second unit of operation alternately.

9. A memory control method that controls an access to a memory divided into a plurality of units of operation, the memory control method comprising:
receiving a plurality of read requests including bank identification information that corresponds to both a first bank included in a first unit of operation and a second bank included in a second unit of operation when the first unit of operation and the second unit of operation from among the plurality of units of operation constitute a memory mirror;
determining an access target of each read access so that a plurality of read accesses based on the plurality of read requests are made to the first unit of operation and the second unit of operation alternately; and
controlling each read request so that each read access is made to a unit of operation determined as the access target.
